(19) United States
(12) Patent Application Publication
(10) Pub. No.: US 2019/0289265 A1
(43) Pub. Date: Sep. 19, 2019

(54) IMAGE PROJECTION APPARATUS AND CONTROL METHOD

(71) Applicant: Yoshito SAITO, Kanagawa (JP)

(72) Inventor: Yoshito SAITO, Kanagawa (JP)

(73) Assignee: Ricoh Company, Ltd., Tokyo (JP)

(21) Appl. No.: 16/281,590

(22) Filed: Feb. 21, 2019

(30) Foreign Application Priority Data
Mar. 19, 2018 (JP) 2018-051771

(51) Int. Cl. H04N 9/31; G03B 21/20

(52) U.S. Cl. CPC H04N 9/3188; G03B 21/008; H04N 9/3155; G03B 21/2053

(57) ABSTRACT

An image projection apparatus for increasing resolution of a projection image by moving an image display element is provided. The image projection apparatus includes a controller, a driving force generator configured to receive a first signal from the controller so as to generate a driving force for moving the image display element, a position detector configured to detect a position of the image display element driven by the driving force, and to transmit a second signal to the controller, and a light source controller configured to receive a third signal from the controller so as to start power supply to a light source, wherein the power supply to the light source is started, in response to the image display element having moved to a reference position after power of the image projection apparatus is turned on.

### CROSS-REFERENCE TO RELATED APPLICATION

The present application claims priority under 35 U.S.C. § 119 to Japanese Patent Application No. 2018-051771, filed on Mar. 19, 2018, the entire contents of which are incorporated herein by reference.

### BACKGROUND OF THE INVENTION

### 1. Field of the Invention

The disclosures herein generally relate to an image projection apparatus and a control method.

### 2. Description of the Related Art

A method for increasing the resolution of a projection image by shifting, for example, a digital micromirror device (DMD) (hereinafter simply referred to as a “DMD”) is known.

As such a method, a method for projecting an image to a desired position by performing lens shifts and foot adjustments is known (Patent Document 1, for example).

However, in the conventional method, an image is often projected even when an image display element is being moved to a reference position.

### RELATED-ART DOCUMENTS

### Patent Documents

[Patent Document 1] Japanese Unexamined Patent Application Publication No. 2006-201673

### SUMMARY OF THE INVENTION

According to one embodiment of the present invention, an image projection apparatus for increasing resolution of a projection image by moving an image display element is provided. The image projection apparatus includes a controller, a driving force generator configured to receive a first signal from the controller so as to generate a driving force for moving the image display element, a position detector configured to detect a position of the image display element driven by the driving force, and to transmit a second signal to the controller, and a light source controller configured to receive a third signal from the controller so as to start power supply to a light source, wherein the power supply to the light source is started, in response to the image display element having moved to a reference position after power of the image projection apparatus is turned on.

### BRIEF DESCRIPTION OF THE DRAWINGS

FIG. 1 is a diagram illustrating an example of an image projection apparatus according to an embodiment;

FIG. 2 is a control block diagram illustrating an example of a general arrangement of a projector according to the embodiment;

FIG. 3 is a perspective view of an optical engine according to the embodiment;

FIG. 4 is a schematic view illustrating an internal configuration of the optical engine according to the embodiment;

FIG. 5 is a schematic view of illustrating an internal configuration of the optical engine according to the embodiment;

FIG. 6 is a perspective view illustrating an example of an image forming unit according to the embodiment;

FIG. 7 is an exploded perspective view illustrating an example of the image forming unit according to the embodiment;

FIG. 8 is an exploded perspective view illustrating a configuration example of a driving force generating unit according to the embodiment;

FIG. 9 is an exploded perspective view illustrating a configuration example of a position detecting unit according to the embodiment;

FIG. 10 is an exploded perspective view illustrating a configuration example of a cooling unit according to the embodiment;

FIG. 11 is an exploded perspective view illustrating a configuration example of movable portions of the image forming unit according to the embodiment;

FIG. 12 is a flowchart illustrating a process performed in response to the power being turned on;

FIG. 13 is a flowchart illustrating a process performed in response to the power being turned off; and

FIG. 14 is a functional block diagram illustrating an example of a functional configuration of the image projection apparatus according to the embodiment.

### DESCRIPTION OF THE PREFERRED EMBODIMENTS

It is a general object of at least one embodiment of the present invention to provide an image projection apparatus that prevents an image from being projected when an image display element is being moved to a reference position.

In the following, embodiments of the present invention will be described with reference to the accompanying drawings. The embodiments are not intended to be limited by the following description, and may be appropriately modified without departing from the gist of the present invention. Furthermore, in the following description, a side where a first movable plate is disposed may be referred to as a “top” side or an “upper” side, and a side where a heat sink is disposed may be referred to as a “bottom” side or a “lower” side.

### <Example of Image Projection Apparatus>

An example in which an image projection apparatus is a projector will be described below.

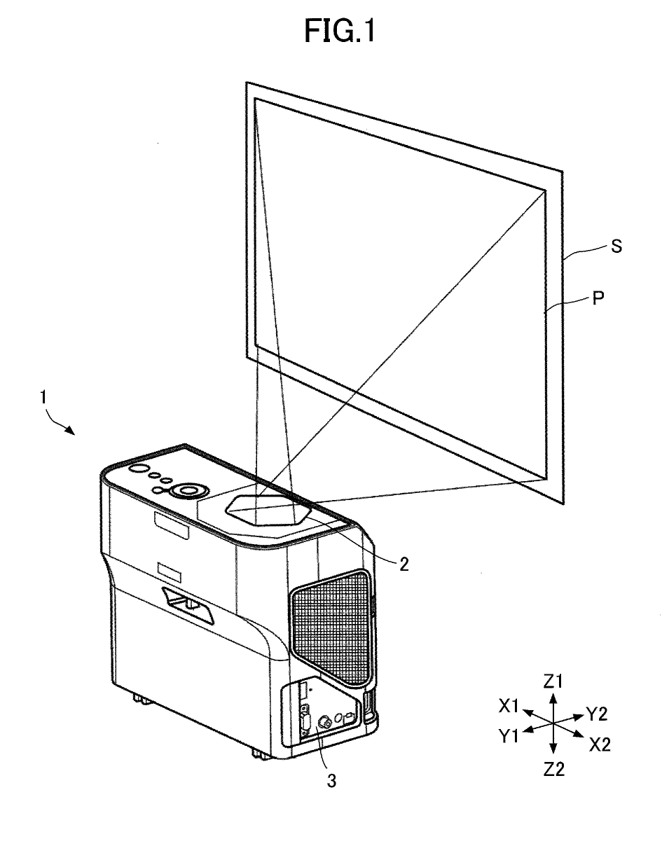

FIG. 1 is a diagram illustrating an example of an image projection apparatus according to an embodiment. In this example, a projector 1 includes a light emission window 2 and an external interface (external I/F) 3, and includes an optical engine that generates a projection image. In the projector 1, for example, when image data is transmitted from an external device, such as a personal computer or a digital camera, connected to the external I/F 3, the optical engine generates a projection image based on the transmitted image data, and a projection image P is projected onto a screen S from the light emission window 2.

In the drawings, an X1-X2 direction (an X-axis direction) is a width direction of the projector 1. A Y1-Y2 direction (a Y-axis direction) is a depth direction of the projector 1. A Z1-Z2 direction (a Z-axis direction) is a height direction of the projector 1. Also, in the following description, a light emission window 2 side of the projector 1 may be referred to as a “top” side, and the opposite side from the light emission window 2 may be referred to as a “bottom” side in the Z axis direction.

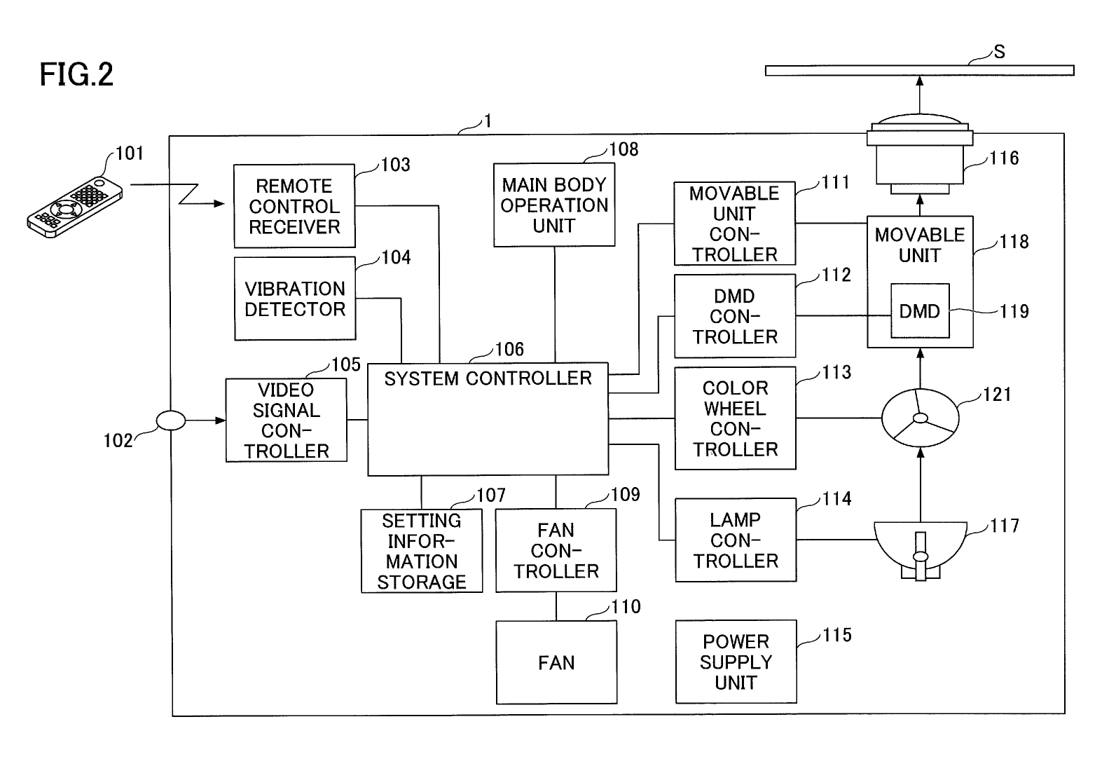

FIG. 2 is a control block diagram illustrating an example of a general arrangement of the projector according to the embodiment. In the illustrated example, the projector 1 includes a switch 102, a remote control receiver 103, a vibration detector 104, a video signal controller 105, a system controller 106, a setting information storage 107, a main body operation unit 108, a fan controller 109, and a fan 110. Further, the projector 1 includes a movable unit controller 111, a DMD controller 112, a color wheel controller 113, a lamp controller 114, a power supply unit 115, a lens 116, a light source lamp 117, a movable unit 118, a DMD 119, and a color wheel 121.

For example, as illustrated, a user operates a remote control 101 to operate the projector 1. To be more specific, the remote control 101 has a power button. By pressing the power button of the remote control 101, the user can turn on and off the power of the projector 1.

The remote control receiver 103 receives an operation performed on the remote control 101. Namely, when the user performs an operation on the remote control 101, the remote control 101 transmits a signal indicating the operation. The remote control receiver 103 receives the signal transmitted from the remote control 101, and inputs the operation performed by the user. Further, the remote control receiver 103 indicates the content of the received operation to the system controller 106. For example, the remote control receiver 103 is an optical sensor.

It is noted that an operation other than an operation for turning on or off the power of the projector 1 may be input from the remote control 101. For example, an operation for changing setting information of the projector 1 may be input from the remote control 101.

The vibration detector 104 detects vibrations. For example, the vibration detector 104 is a vibration sensor.

The video signal controller 105 controls projection of a projection image P based on an operation of the switch 102. For example, the video signal controller 105 is a control circuit.

The system controller 106 performs processes of the projector 1. For example, the system controller 106 is an arithmetic device and a control device such as a central processing unit (CPU).

The setting information storage 107 stores various setting information of the projector 1. The setting information is preliminarily input by, for example, the user. The setting information storage 107 is, for example, a storage device.

The main body operation unit 108 controls hardware of the projector 1 based on an input operation. For example, the main body operation unit 108 is, for example, a control device.

The fan controller 109 controls the fan 110. The fan controller 109 is, for example, a control device.

The movable unit controller 111 controls the movable unit 118. Namely, the movable unit controller 111 transmits a position control signal to actuators for moving the movable unit 118 so as to change the position of the movable unit 118. In the illustrated example, the movable unit 118 includes the DMD 119. The DMD 119 is an example of an image display element. When the movable unit 118 moves, the DMD 119 moves together. Thus, the movable unit controller 111 moves the DMD 119 to a predetermined position by controlling the movable unit 118. When the DMD 119 moves, an image projected by the DMD 119 moves together. The movable unit controller 111 is, for example, an electronic circuit.

Also, the movable unit controller 111 detects a position of the movable unit 118, namely detects a position of the DMD 119. In other words, a position of the movable unit 118 is detected by, for example, a sensor. Then, a result of the detected position is fed back to the movable unit controller 111.

The DMD controller 112 controls the DMD 119. Namely, the DMD controller 112 performs various controls such that the DMD 119 generates a projection image. The DMD controller 112, is for example, an electronic circuit.

The color wheel controller 113 controls rotation of the color wheel 121. The color wheel controller 113 is, for example, an electronic circuit.

The lamp controller 114 controls the light source lamp 117. For example, the lamp controller 114 controls power supply to the light source lamp 117 in order to turn on and off the light source lamp 117. The lamp controller 114 is, for example, an electronic circuit.

The power supply unit 115 controls power supply to the projector 1. The power supply unit 115 is, for example, an electronic circuit. The power supply unit 115 may be controlled by the system controller 106.

The lens 116 includes, for example, optical components such as a plurality of projection lenses and mirrors. The lens 116 enlarges an image generated by the DMD 119 and projects the image onto the screen S.

### <Example of Optical Engine>

A configuration example of an optical engine 25 will be described below.

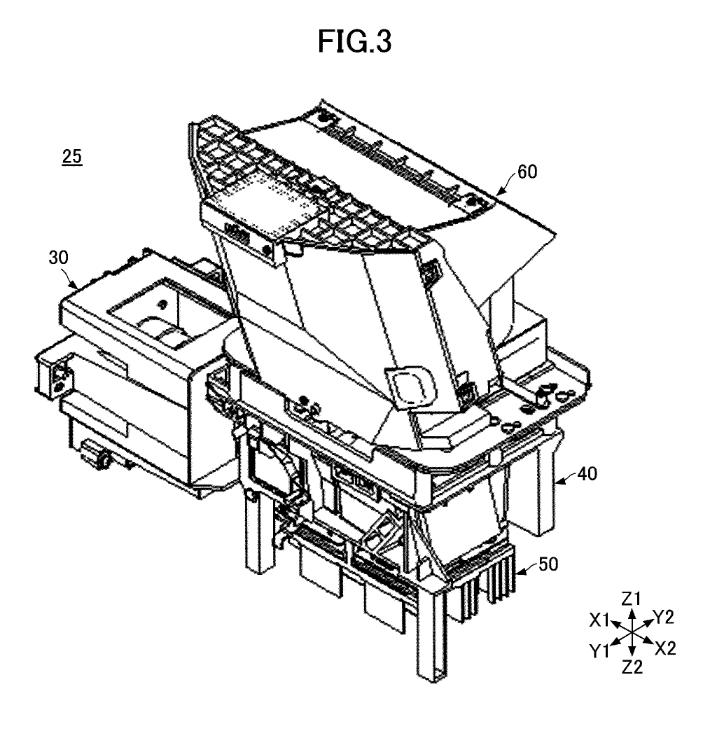

FIG. 3 is a perspective view of the optical engine 25 according to the embodiment. In the illustrated example, the optical engine 25 is provided inside the projector 1. The optical engine includes a light source 30, an illumination optical system unit 40, an image forming unit 50, and a projection optical system unit 60.

In the illustrated example, the light source 30 is provided on the side surface of the illumination optical system unit 40, and emits light in the X2 direction. Next, the illumination optical system unit 40 guides the light emitted from the light source 30 to the image forming unit 50 located at the lower part. Subsequently, the image forming unit 50 uses the light guided by the illumination optical system unit 40 to generate a projection image. Further, the projection optical system unit 60 is provided above the illumination optical system unit 40, and projects the projection image generated by the image forming unit 50 to the outside of the projector 1.

In the illustrated example, the optical engine 25 projects an image in the upward direction by using the light emitted from the light source 30; however, the direction in which the image is projected is not limited to the upward direction. For example, the image may be projected in the horizontal direction.

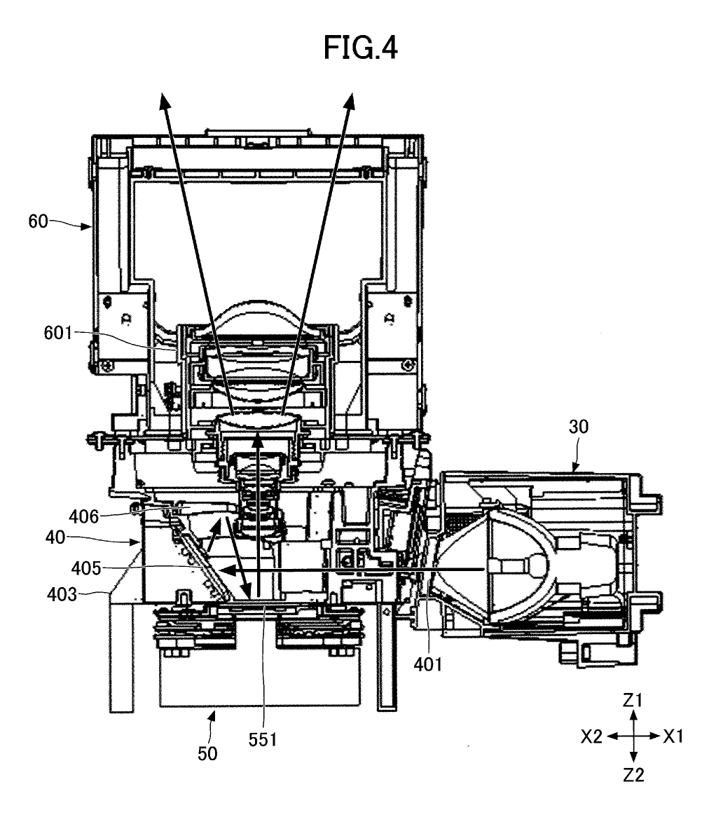

FIG. 4 is a schematic view illustrating an internal configuration of the optical engine 25 according to the embodiment.

As illustrated in FIG. 4, the illumination optical system unit 40 includes a color wheel 401, a plane mirror 405, and a concave mirror 406.

The color wheel 401 is, for example, a disk having filters of respective colors of R (red), G (green), and B (blue) at different portions in the circumferential direction. By rotating the color wheel 401 at a high speed, the light emitted from the light source 30 is time-divided into the respective colors of RGB.

The plane mirror 405 and the concave mirror 406 reflect the light, which is time-divided into the respective colors of RGB by the color wheel 401, to the DMD 551 of the image forming unit 50. Also, the color wheel 401, the plane mirror 405, and the concave mirror 406 are supported by a base 403. The base 403 is fixed inside a housing of the projector 1.

In the illumination optical system unit 40, for example, a light tunnel or a relay lens may be provided between the color wheel 401 and the plane mirror 405.

The DMD 551 modulates the light reflected from the concave mirror 406 so as to generate a projection image. The projection image generated by the DMD 551 is guided through the illumination optical system unit 40 to the projection optical system unit 60.

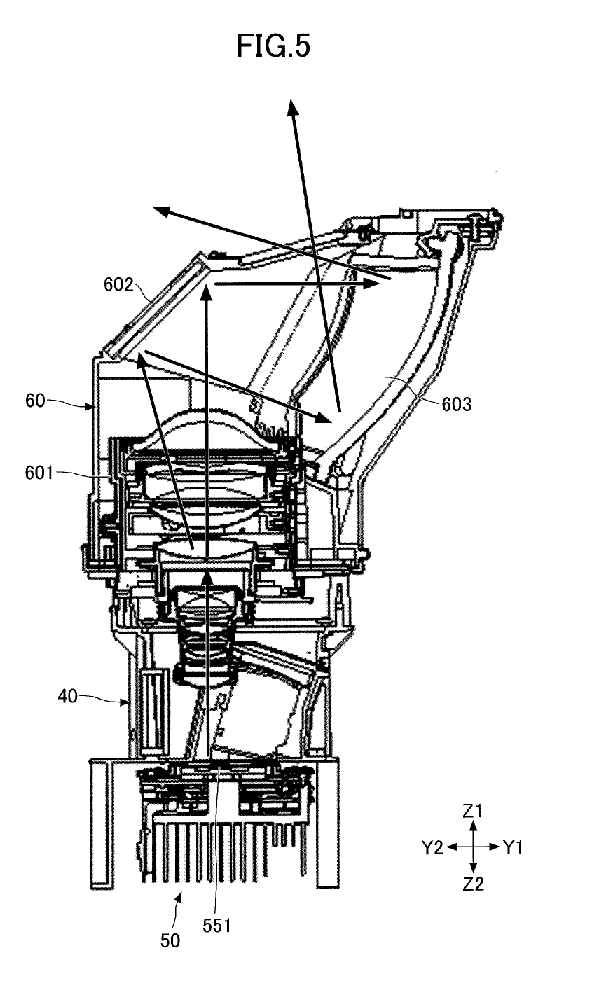

FIG. 5 is a schematic view illustrating an internal configuration of the optical engine 25 according to the embodiment.

As illustrated in FIG. 4 and FIG. 5, the projection optical system unit 60 includes a projection lens 601, a turning-back mirror 602, and a curved mirror 603 inside a case.

The projection lens 601 includes a plurality of lenses. The projection lens 601 forms a projection image generated by the DMD 551 on the turning-back mirror 602. Next, the turning-back mirror 602 and the curved mirror 603 reflect the formed projection image so as to enlarge and project the projection image onto the screen S located outside the projector 1.

### <Example of Image Forming Unit>

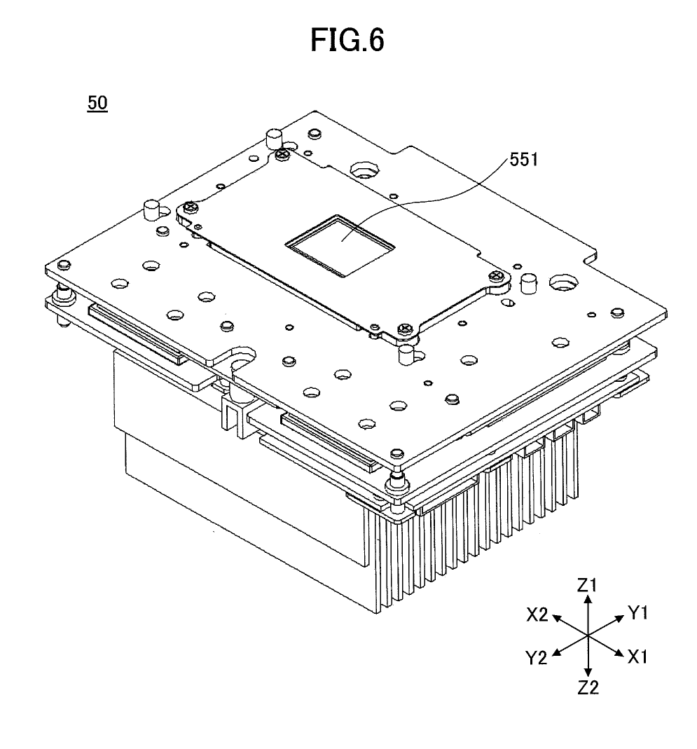

FIG. 6 is a perspective view illustrating an example of the image forming unit 50 according to the embodiment.

In the following, as illustrated, an image forming unit including an optical unit in which an optical element is an image forming element will be described as an example. In this example, the DMD 551 is the image forming element.

The image projection apparatus includes, for example, the image forming unit 50 as illustrated in FIG. 6, and projects an image generated by the image forming unit 50 onto the screen S.

Further, the image forming unit 50 moves the DMD 551 by approximately half a pixel, for example. In this manner, when the DMD 551 is moved, the image projection apparatus can form an intermediate image on the screen S, and can thus increase the resolution of a projection image.

The image forming unit 50 has the following configuration, for example.

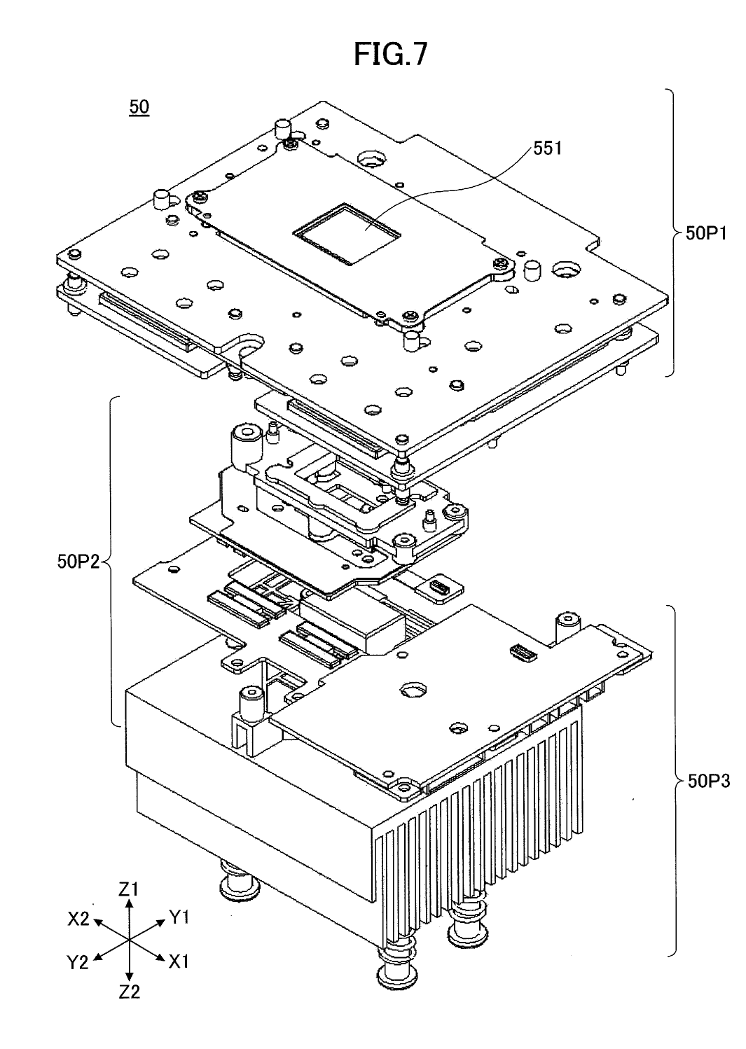

FIG. 7 is an exploded perspective view illustrating an example of the image forming unit 50 according to the embodiment.

As illustrated, the image forming unit 50 includes a driving force generating unit 50P1, a position detecting unit 50P2, and a cooling unit 50P3, for example. A detailed description of each of the units will be provided in order below.

### <Example of Driving Force Generating Unit>

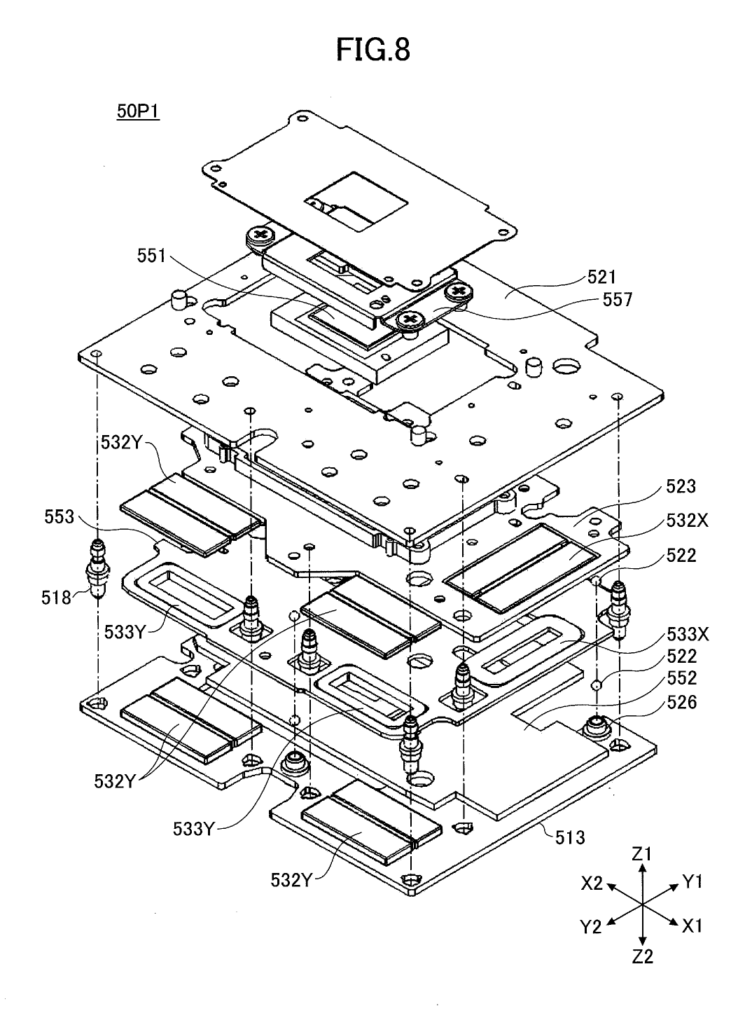

FIG. 8 is an exploded perspective view illustrating a configuration example of the driving force generating unit 50P1 according to the embodiment.

In the illustrated example, the driving force generating unit 50P1 includes a driving magnet 532X, a driving magnet 532Y, a voice coil 533X, and a voice coil 533Y, which are actuators for moving the DMD 551. As described, the driving force generating unit 50P1 has a configuration including electromagnetic actuators.

Further, in the illustrated example, the driving force generating unit 50P1 includes movable plates such as a first movable plate 553 and a second movable plate 552 so as to transmit movement to the DMD 551. More specifically, in this example, the voice coil 533X and the voice coil 533Y are disposed on the first movable plate 553.

When an electric current flows through the voice coil 533X and the voice coil 533Y, a Lorentz force serving as a driving force is generated by a magnetic field formed by the driving magnet 532X and the driving magnet 532Y.

When the driving force generated by the voice coil 533X and the voice coil 533Y acts on the first movable plate 553, the first movable plate 553 moves relative to a first fixed plate 521, a second fixed plate 513, and a third fixed plate 523.

Also, in the illustrated example, balls 522 and a ball supporting part 526 are disposed. The balls 522 are disposed between the first movable plate 553 and the first fixed plate 521, and between the second movable plate 552 and the second fixed plate 513. In this way, the driving force generating unit 50P1 has a configuration in which movable portions make point contact with fixed portions. Therefore, the balls 522 and the ball supporting part 526 can reduce friction generated when driving force generating unit 50P1 is driven.

Further, in the illustrated example, the fixed portions such as the first fixed plate 521, the second fixed plate 513, and the third fixed plate 523 are connected by supports 518. Also, in the illustrated example, a DMD cover 557 is provided for the DMD 551.

In the following, the second movable plate 552 is regarded as a substrate on which the DMD 551 is disposed.

### <Example of Position Detecting Unit>

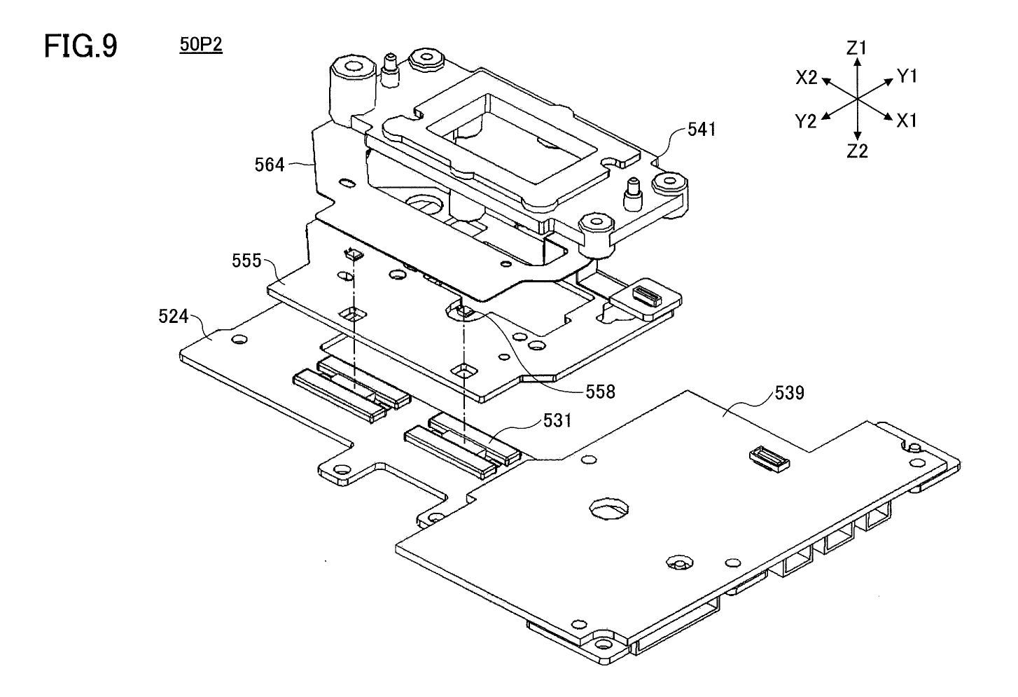

FIG. 9 is an exploded perspective view illustrating a configuration example of the position detecting unit 50P2 according to the embodiment.

In the illustrated example, the position detecting unit 50P2 includes a Hall element 558 and a position detection magnet 531, in order to detect an amount of movement of the DMD 551. Therefore, in this example, the first movable plate 553 and the second movable plate 552, which constitute the driving force generating unit 50P1, and the Hall element 558 move integrally.

Thus, in this example, the position detecting unit 50P2 includes a first member 541. The first member 541 is an example of a first portion, and the first movable plate 553 and the second movable plate 552 are attached to the first member 541.

In FIG. 9, the Hall element 558 is described as a single unit; however, the Hall element 558 is mounted on a position detection flexible printed wiring board (FPC) 564. The position detection FPC 564 is attached to a third movable plate 555. Therefore, in the illustrated example, when the third movable plate 555 moves, the Hall element 558 also moves together with the third movable plate 555. It is noted that the third movable plate 555 moves relative to a fixed portion such as a fourth fixed plate 524.

Also, in the illustrated example, the position detection FPC 564, on which the Hall element 558 is mounted, is electrically connected to a control board 539. The Hall element 558 is a type of a magnetic sensor and detects a change in magnetic flux of the position detection magnet 531. The control board 539 performs a calculation to convert the change in the magnetic flux of the position detection magnet 531 detected by the Hall element 558, into an amount of movement. Next, the control board 539 determines an amount of an electric current to be supplied to the voice coil 533X and the voice coil 533Y based on the calculated amount of movement.

### <Example of Cooling Unit>

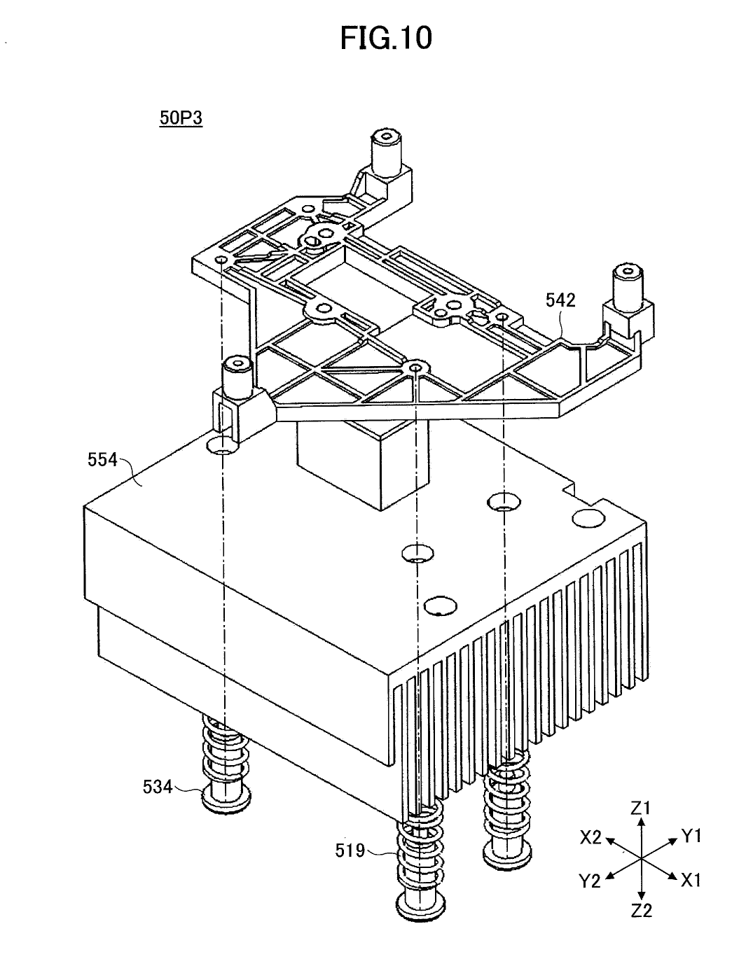

FIG. 10 is an exploded perspective view illustrating a configuration example of the cooling unit 50P3 according to the embodiment.

In the illustrated example, the cooling unit 50P3 includes a heat sink 554 so as to cool the DMD 551. The heat sink 554 is as an example of a heat dissipation member. When the heat sink 554 is pressed against the DMD 551, heat generated by the DMD 551 is released from the heat sink 554.

Further, in this example, in order to press the heat sink 554 against the DMD 551, fixing members such as a stepped screw 534 and a compression spring 519 are used. It is noted that the fixing members are not limited to the stepped screw 534 and the compression spring 519, and any mechanism component that can attach the heat sink 554 may be used.

Also, in this example, the heat sink 554 is movable. Therefore, the heat sink 554 is directly or indirectly coupled to the first movable plate 553. To be more specific, the cooling unit 50P3 includes a second member 542. The second member 542 is an example of a second portion, and is attached to the first movable plate 553. With such a configuration, when the first movable plate 553 moves, the movement of the first movable plate 553 is transmitted to the second member 542. Further, the movement of the first movable plate 553 is transmitted to the heat sink 554 via the stepped screw 534 attached to the second member 542.

The heat sink 554 is pressed against the DMD 551 by the stepped screw 534 and the compression spring 519. Therefore, the position of the heat sink 554 in the Z-axis is determined by the position of the back surface of the DMD 551. The position of the heat sink 554 in the X-axis and the Y-axis has degrees of freedom for play of the stepped screw 534.

In the illustrated example, the stepped screw 534 penetrates the heat sink 554, and is attached to the second member 542. Further, a pressing force is generated by the compression spring 519. More specifically, the heat sink 554 is pressed against the DMD 551 by an elastic force of the compression spring 519 compressed between the seating surface of the stepped screw 534 and the base surface of the heat sink 554.

In the illustrated example, a reaction force against the elastic force of the compression spring 519 acts on the second member 542. Namely, with such a configuration, the reaction force is not directly transmitted to the substrate on which the DMD is mounted. Therefore, due to the rigidity of the second member 542, the deflection of the substrate on which the DMD is mounted, can be reduced.

### <Example of Movable Portions>

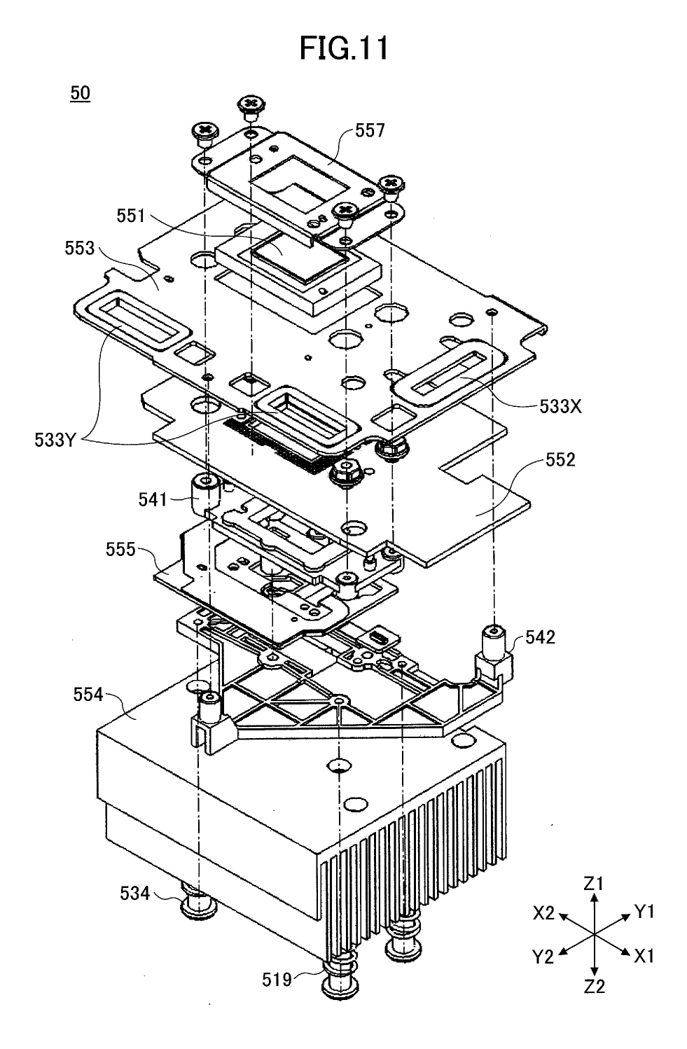

FIG. 11 is an exploded perspective view illustrating a configuration example of movable portions of the image forming unit 50 according to the embodiment. FIG. 11 illustrates movable portions included in the configuration of the image forming unit 50. Namely, FIG. 11 illustrates the image forming unit 50 in which the fixed portions such as the first fixed plate 521, the second fixed plate 513, the third fixed plate 523, the supports 518, the driving magnet 532X, the driving magnet 532Y, the balls 522, and the ball supporting part 526 are not depicted.

As illustrated, a driving force generated by the voice coil 533X and the voice coil 533Y acts on the first movable plate 553 first.

Next, the second member 542 is attached to the first movable plate 553, and, therefore, the movement of the first movable plate 553 is transmitted to the second member 542. Also, the first member 541 is attached to the second member 542, and, therefore, the movement of the first movable plate 553 is transmitted to the first member 541.

Further, the second movable plate 552, on which the DMD 551 is disposed, and the third movable plate 555 are attached to the first member 541. Thus, the movement of the first movable plate 553 causes the second movable plate 552 and the third movable plate 555 to move. As a result, the DMD 551 moves.

Then, the Hall element 558 detects the movement by the first movable plate 553.

In the illustrated configuration, for example, the first movable plate 553 is one example of the movable portions. However, the movable portions may be any portions as long as the DMD 551 can be moved. In the illustrated configuration, the first fixed plate 521 is one example of the fixed portions.

### <Example of Overall Process>

A process performed in response to the power of the projector being turned on by the remote control 101 will be described below.

### <Example of Process Performed in Response to Power Being Turned On>

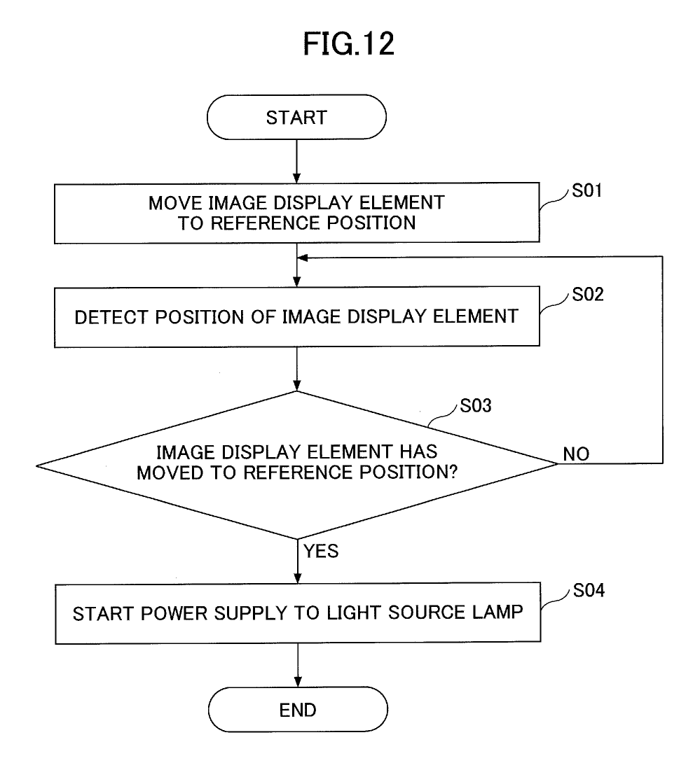

FIG. 12 is a flowchart illustrating a process performed in response to the power being turned on. In other words, the projector starts the following process in response to a user pressing the power button of the remote control 101 so as to turn the power on. In the illustrated process, before step S04 is performed, namely in an initial state, the light source lamp is turned off. Thus, the initial state is a state before the projector projects a projection image.

In step S01, a driving force generator moves the image display element to a reference position. The reference position is preliminarily set in setting information, for example. More specifically, the reference position is set to an approximate center position of a movable range of the image display element. This setting is for the projector to perform what is known as centering. It is noted that the reference position is not necessarily the center position for centering, and may be any preliminarily set position.

Therefore, in step S01, a position control signal for moving the image display element to the reference position is transmitted. When the reference position is transmitted to the driving force generator, a driving force for moving the image display element is generated, causing the image display element to move toward the reference position.

In step S02, a position detector detects a position of the image display element. To be more specific, after step S01 is performed, a detection control signal is transmitted, and step S02 is started. Namely, a position of the image display element that has moved in step S01 is detected by, for example, a sensor.

In step S03, the position detector determines whether the image display element has moved to the reference position. Namely, the position detector determines whether a detection result obtained in step S02 matches the reference position by comparison. The determination as to whether the detection result matches the reference position may be made by taking allowable error into account.

When the position detector determines that the image display element has moved to the reference position (yes in step S03), the projector causes the process to proceed to the step S04. Conversely, when the position detector determines that the image display element has not moved to the reference position (no in step S03), the projector causes the process to return to step S02.

Also, when it is detected that the image display element has moved to the reference position (yes in step S03), a light source control signal for turning the light source lamp on is transmitted to a light source controller.

In step S04, the light source controller turns the light source lamp on. Namely, the light source controller starts power supply to the light source lamp. In this way, when power supply to the light source lamp is started, the light source lamp lights up, allowing a projection image to be projected.

Also, when the projector being turned on is turned off by the remote control 101, the following process is desirably performed.

### <Example of Process Performed in Response to Power of Projector Being Turned Off>

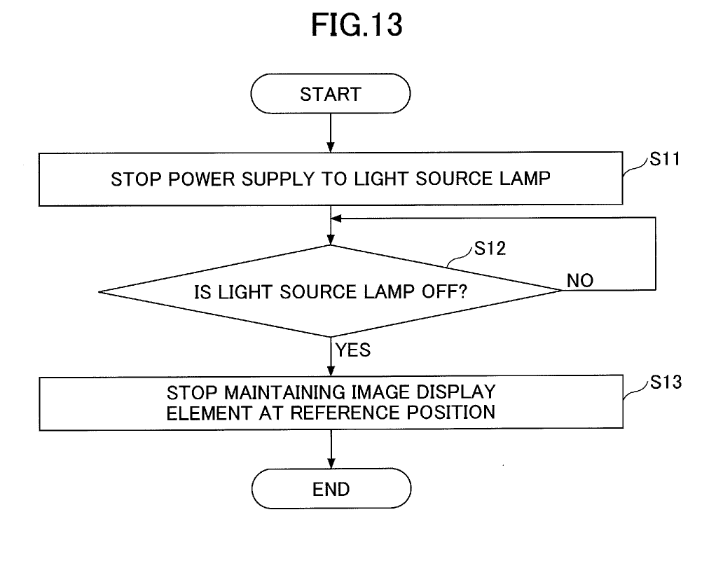

FIG. 13 is a flowchart illustrating a process performed in response to the power being turned off. The process as illustrated in FIG. 13 is performed in a situation where the light source lamp had been turned on by the light source controller, and subsequently the user presses the power button of the remote control 101 so as to turn the power of the projector off.

In step S11, the light source controller turns the light source lamp off. Namely, the light source controller stops the power supply to the light source lamp. In this way, when the power supply is stopped, the light source lamp is turned off. Thus, a projection image will not be projected.

In step S12, the controller determines whether the light source lamp is off. When the controller determines that the light source lamp is off (yes in step S12), the projector causes the process to proceed to step S13. Conversely, when the controller determines that the light source lamp is not off (no in step S12), the projector causes the process to repeat step S12. Namely, the projector waits until the light source lamp becomes off.

In step S13, the driving force generator stops maintaining the image display element at the reference position. More specifically, when the controller detects that the light source lamp is off (yes in step S12), the controller transmits a stop signal for stopping maintaining the image display element at the reference position.

### <Example of Functional Configuration>

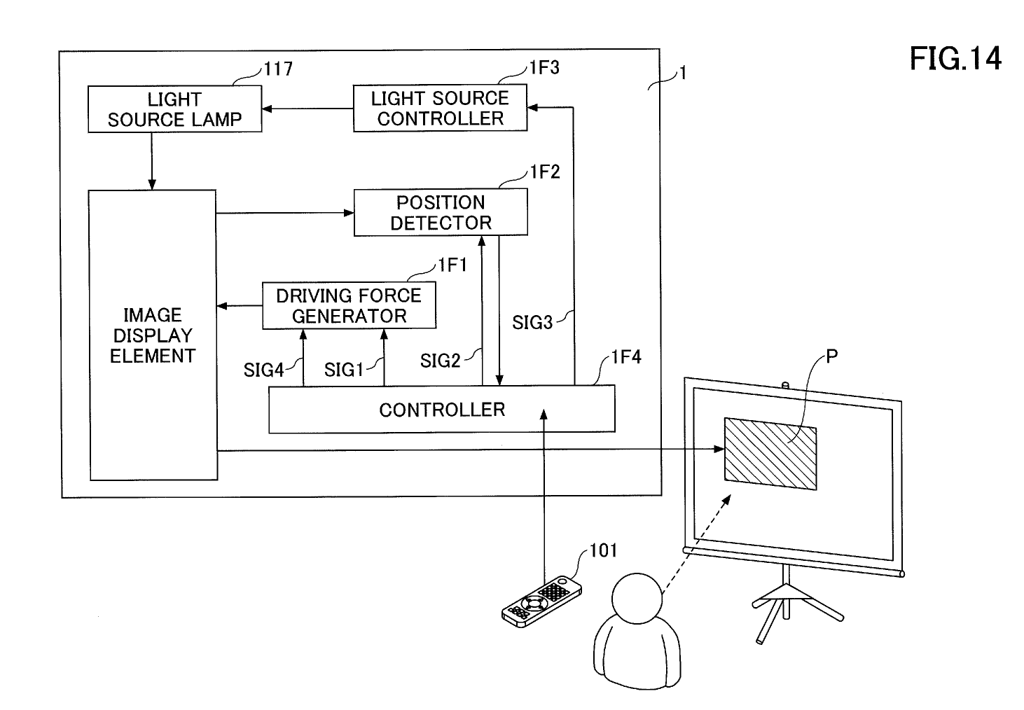

FIG. 14 is a functional block diagram illustrating an example of a functional configuration of the image projection apparatus according to the embodiment. For example, as illustrated in FIG. 14, the projector 1 has a functional configuration including a driving force generator 1F1, a position detector 1F2, a light source controller 1F3, and a controller 1F4.

The driving force generator 1F1 performs a driving force generating process for generating a driving force for driving the image display element such as the DMD. For example, the driving force generator 1F1 is implemented by the movable unit 118.

The position detector 1F2 performs a position detecting process for detecting a position of the image display element. For example, the position detector 1F2 is implemented by the movable unit 118.

The light source controller 1F3 performs a light source control process for controlling power supply to the light source lamp 117. For example, the light source controller 1F3 is implemented by the lamp controller 114.

The controller 1F4 performs a control process for creating a projection image P. For example, the controller 1F4 is implemented by the system controller 106.

In the illustrated functional configuration, in response to the power of the projector being turned on, the controller 1F4 transmits, to the driving force generator 1F1, a position control signal SIG1 for moving the image display element to the reference position. In response to receiving the position control signal SIG1, the driving force generator 1F1 generates a driving force so as to move the image display element.

Further, in response to the power being turned on, the controller 1F4 transmits, to the position detector 1F2, a detection control signal SIG2 for detecting a position of the image display element. In response to receiving the detection control signal SIG2, the position detector 1F2 detects a position of the image display element, and feeds back a detection result to the controller 1F4. Therefore, the controller 1F4 can identify the position of the image display element.

Next, when the controller 1F4 detects that the image display element has moved to the reference position, the controller 1F4 transmits, to the light source controller 1F3, a light source control signal SIG3 for turning the light source lamp 117 on. Then, in response to receiving the light source control signal SIG3, the light source controller 1F3 starts power supply to the light source lamp 117 so as to turn the light source lamp 117 on.

In response to the light source lamp 117 being off, the controller 1F4 transmits, to the driving force generator 1F1, a stop signal SIG4 for stopping maintaining the image display element at the reference position. Namely, the stop signal SIG4 causes the image projection apparatus to stop driving the image display element after the light source lamp 117 is off.

### <Effects>

With the above-described configuration, the image projection apparatus can turn the light source lamp on when the image display element has moved to the reference position. Thus, the image projection apparatus can prevent an image from being projected when the image display element is being moved to the reference position.

For example, if the light source lamp was turned on while the image display element was moving to the reference position, an image would be projected in the process of moving the image display element to the reference position. If the image was projected while the image display element was moving, the projected image would be largely moved. This would often surprise users, and would cause some users to feel discomfort.

In light of the above, according to the present embodiment, the image projection apparatus can prevent an image that causes a user to feel discomfort from being projected, by turning the light source lamp on when the image display element has moved to the reference position.

Also, when the image projection apparatus is stopped being used, the power is turned off. Then, when the light source lamp is off, namely when no image is being projected, centering is turned off. In this manner, the image projection apparatus can prevent an image that causes a user to feel discomfort from being projected.

### <Example of Image Projection>

For example, during image projection, the position of the DMD 551 is controlled such that the DMD 551 moves, at a high speed, between a plurality of positions separated by a distance less than arrangement intervals of a plurality of micromirrors of the DMD 551, at a cycle based on a frame rate. Then, position information detected by the sensor is used to transmit an image signal to the DMD 551 so as to generate a projection image shifted according to the positions of the DMD 551.

For example, the DMD 551 is moved back and forth at a predetermined cycle between positions separated by a distance less than the arrangement intervals of the micromirrors of the DMD 551, in the X direction and the Y direction. Then, the DMD 551 is controlled so as to generate a projection image shifted according to the positions of the DMD 551. Thus, the resolution of the projection image can be approximately twice the resolution of the DMD 551. Furthermore, if moving positions of the DMD 551 are increased, the resolution of the projection image can be made above twice the resolution of the DMD 551.

As described, the image projection apparatus causes the DMD 551 to shift, and a projection image to be generated according to positions of the DMD 551. In this manner, it becomes possible to project an image with higher resolution than that of the DMD 551.

### Other Embodiments

It is noted that the above-described configuration of, for example, the cooling unit is not required. For example, in order to enhance the cooling effect of the DMD 551, an elastically deformable heat transfer sheet may be provided between the heat sink 554 and the DMD 551. If the heat transfer sheet is provided, thermal conductivity between the heat sink 554 and the DMD 551 improves, thus allowing the cooling effect of the DMD 551 to be enhanced.

Further, at least one or more of the movable plates and the fixed plates preferably include a conductive material such as stainless steel, aluminum, and a magnesium alloy. With such a configuration, electrical noise generated in the DMD 551 or in the substrate on which the DMD 551 is mounted can be released through the conductive material to, for example, the housing. Therefore, noise leakage to the outside can be reduced.

In the above embodiments, a yoke plate may be formed by using a plate of a magnetic material. With such a configuration, the generated magnetic flux concentrates on the plate functioning as the yoke plate, and thus, leakage of the magnetic flux can be reduced.

It is noted that the image projection apparatus may be more than one apparatus. Namely, the image projection apparatus may be a system including a plurality of apparatuses. For example, in the system, the plurality of apparatuses may perform processes related to a control method in a distributed, redundant, or parallel manner.

The processes related to the control method may be implemented by a program. In other words, the control method may be executed by causing a computer including an arithmetic device and a storage device to perform the processes related to the control method in accordance with the program.

According to at least one embodiment of the present invention, it is possible to prevent an image from being projected when an image display element is being moved to a reference position.

Further, the present invention is not limited to these embodiments, but various variations and modifications may be made without departing from the scope of the present invention.

What is claimed is:

1. An image projection apparatus for increasing resolution of a projection image by moving an image display element, the image projection apparatus comprising:
a controller;
a driving force generator configured to receive a first signal from the controller so as to generate a driving force for moving the image display element;
a position detector configured to detect a position of the image display element driven by the driving force, and to transmit a second signal to the controller; and
a light source controller configured to receive a third signal from the controller so as to start power supply to a light source,
wherein the power supply to the light source is started, in response to the image display element having moved to a reference position after power of the image projection apparatus is turned on.

2. The image projection apparatus according to claim 1, wherein, in response to the light source being off, the controller transmits, to the driving force generator, a stop signal for stopping maintaining the image display element at the reference position.

3. The image projection apparatus according to claim 1, wherein the controller, the driving force generator, the position detector, and the light source controller are implemented by an electronic circuit.

4. A control method performed by an image projection apparatus for increasing resolution of a projection image by moving an image display element, the control method comprising:
receiving a first signal so as to generate a driving force for moving the image display element;
detecting a position of the image display element driven by the driving force, and transmitting a second signal; and
receiving a third signal so as to start power supply to a light source,
wherein the power supply to the light source is started, in response to the image display element having moved to a reference position after power of the image projection apparatus is turned on.
